(19) United States
(12) Patent Application Publication
(10) Pub. No.: US 2025/0055018 A1
(43) Pub. Date: Feb. 13, 2025

(54) Electrode Assembly and Battery Cell Including the Same

(71) Applicant: LG Energy Solution, Ltd., Seoul (KR)

(72) Inventors: Daesoo Kim, Daejeon (KR); Youngdeok Kim, Daejeon (KR); Soon Hyung Choi, Daejeon (KR)

(73) Assignee: LG Energy Solution, Ltd., Seoul (KR)

(21) Appl. No.: 18/721,515

(22) PCT Filed: Feb. 22, 2023
(86) PCT No.: PCT/KR2023/002536

§ 371 Date: Jun. 18, 2024

(30) Foreign Application Priority Data
Apr. 25, 2022 (KR) 10-2022-0050981
Feb. 20, 2023 (KR) 10-2023-0022115

(51) Int. Cl. H01M 10/04; H01M 50/46

(52) U.S. Cl. CPC H01M 10/0459; H01M 50/46

(57) ABSTRACT

The present disclosure relates to an electrode assembly and a battery cell including the same, and an electrode assembly according to one embodiment of the present disclosure is configured to stack a plurality of unit cells including a negative electrode, a positive electrode and a separator are stacked, and to include a separator located between the plurality of unit cells. The electrode assembly includes a first unit cell in which an end of the negative electrode protrudes more than an end of the positive electrode; and a second unit cell in which an end of the positive electrode protrudes more than an end of the negative electrode.

### CROSS-REFERENCE TO RELATED APPLICATIONS

This application is a national phase entry under 35 U.S.C. § 371 of International Application No. PCT/KR2023/002536 filed on Feb. 22, 2023, which claims the benefit of Korean Patent Application No. 10-2022-0050981 filed on Apr. 25, 2022 and Korean Patent Application No. 10-2023-0022115 filed on Feb. 20, 2023 in the Korean Intellectual Property Office, the entire contents of which are incorporated herein by reference.

### TECHNICAL FIELD

The present disclosure relates to an electrode assembly and a battery cell including the same, and more particularly, to an electrode assembly capable of securing the stability of a battery cell by generating a short circuit under overvoltage conditions, and a battery cell including the same.

### BACKGROUND

With the technology development and increased demand for mobile devices, demand for secondary batteries as energy sources has been rapidly increasing. A variety of researches on batteries capable of meeting various needs have been carried out accordingly.

A secondary battery has attracted considerable attention as an energy source for power-driven devices, such as an electric bicycle, an electric vehicle, and a hybrid electric vehicle, as well as an energy source for mobile devices, such as a mobile phone, a digital camera, and a laptop computer.

Recently, as the need for a large-capacity secondary battery structure is increasing along with the utilization of the secondary battery as an energy storage source, there is a growing demand for a battery pack of middle- or large-sized module structure which is an assembly of battery modules in which a plurality of secondary batteries are connected in series or in parallel.

Currently commercialized secondary batteries include a nickel cadmium battery, a nickel hydrogen battery, a nickel zinc battery, and a lithium secondary battery. Among them, the lithium secondary battery has come into the spotlight because they have advantages, for example, being freely charged and discharged, and having very low self-discharge rate and high energy density.

The secondary battery may be classified, based on the shape of a battery case, into a cylindrical or prismatic battery wherein an electrode assembly is mounted in a cylindrical or prismatic metal can, and a pouch-type battery in which the electrode assembly is mounted in a pouch-shaped case made of an aluminum laminate sheet.

Further, the secondary battery may be classified, based on the structure of an electrode assembly having a structure in which a positive electrode and a negative electrode are stacked with a separator being interposed between the positive electrode and the negative electrode. Typically, there may be mentioned a jelly-roll (wound) type structure in which long sheet-type positive and negative electrodes are wound with a separator interposed therebetween, a stacked (laminated) type structure in which a plurality of positive and negative electrodes cut to a predetermined unit size are stacked in a sequential order with separators interposed therebetween, or the like. In recent years, in order to solve problems caused by the jelly-roll type electrode assembly and the stacked type electrode assembly, there has been developed a stacked/folded type electrode assembly, which is a combination of the jelly-roll type electrode assembly and the stacked type electrode assembly.

FIG. 1 is a side view of a conventional electrode assembly.

Referring to FIG. 1, the electrode assembly is a stacked electrode assembly, which is mainly formed either by stacking a negative electrode 11, a first separator 13, and a positive electrode 12, or by stacking unit cells, in which the positive electrode 12, the first separator 13, and the negative electrode 11 are sequentially stacked, with the second separator 30 interposed therebetween.

Typically, since the first separator 13 is formed longer than the length of the positive electrode 12 or the negative electrode 11, the end of the first separator 13 in the electrode assembly exists in a state it is not adhered to the positive electrode 12 or the negative electrode 11. Here, the first separator 13 and the second separator 30 have substantially the same configuration.

In addition, one end of the negative electrode 11 usually protrudes more than one end of the positive electrode 12. In a unit cell having such a structure, problems such as further decomposition of the electrolyte and oxygen desorption of the positive electrode occur in an overvoltage state in which the operating range of the battery is 4.5 V or more, thereby increasing the possibility of explosion of the battery. Therefore, when the battery is overcharged, there is a need for a technique to prevent the battery from short-circuiting and causing the voltage to rise suddenly.

### DETAILED DESCRIPTION OF THE INVENTION

### Technical Problem

It is an object of the present disclosure to provide an electrode assembly with improved safety and a battery cell including the same.

However, the problem to be solved by embodiments of the present disclosure is not limited to the above-described problems, and can be variously expanded within the scope of the technical idea included in the present disclosure.

### Technical Solution

According to one embodiment of the present disclosure, there is provided an electrode assembly configured to stack a plurality of unit cells including a negative electrode, a positive electrode and a separator are stacked, and to include a separator located between the plurality of unit cells, the electrode assembly comprising: a first unit cell in which an end of the negative electrode protrudes more than an end of the positive electrode; and a second unit cell in which an end of the positive electrode protrudes more than an end of the negative electrode.

The second unit cell includes a second negative electrode, a second positive electrode, and a second separator located between the second negative electrode and the second positive electrode, an end of the second positive electrode protrudes more than an end of the second negative electrode, and a length of the second positive electrode may be longer than a length of the second negative electrode.

A difference between the length of the second negative electrode and the length of the second positive electrode may be less than 1%.

A difference between the length of the second negative electrode and the length of the second positive electrode may be 0.4% or less.

A distance between an end of the second negative electrode and an end of the second separator may be longer than a distance between an end of the second positive electrode and an end of the second separator.

The second unit cell may deposit lithium at a potential lower than that of the first unit cell.

The second unit cell may deposit lithium when the voltage applied to the second unit cell is 4.5V or more and 5.5V or less.

The second unit cell may be configured such that a capacity appearance of the positive electrode of the second unit cell is greater than a capacity appearance of the negative electrode of the second unit cell.

The number of the first unit cell may be at least one or more.

The second unit cell may be an outermost unit cell.

The second unit cell may be located between the plurality of first unit cells.

As the number of the second unit cells increases, the maximum voltage during overcharge of the battery may decrease.

According to another embodiment of the present disclosure, there is provided a battery cell comprising the above-mentioned electrode assembly.

### Advantageous Effects

According to embodiments, the difference in length between one end of the negative electrode and one end of the positive electrode can be used to improve the safety of an electrode assembly and a battery cell including the same.

The effects of the present disclosure are not limited to the effects mentioned above and additional other effects not mentioned above will be clearly understood from the description of the appended claims by those skilled in the art.

### BRIEF DESCRIPTION OF THE DRAWINGS

FIG. 1 is a side view of a conventional electrode assembly.

FIG. 2 is a side view of an electrode assembly according to one embodiment of the present disclosure.

FIG. 3(a) is a perspective view of a first unit cell constituting the electrode assembly according to one embodiment of the present disclosure. FIG. 3(b) is a perspective view of a second unit cell constituting an electrode assembly according to one embodiment of the present disclosure.

FIG. 4 is a perspective view showing a second unit cell in an overcharged state according to one embodiment of the present disclosure.

FIG. 5 is a side view of a unit cell constituting an electrode assembly according to one embodiment of the present disclosure.

FIG. 6 is a graph showing the voltage applied to the battery during overcharge of the battery.

FIG. 7 is a photograph showing a conventional unit cell in an overcharged state.

FIG. 8 is a photograph of a unit cell in an overcharged state according to an embodiment of the present disclosure.

### DETAILED DESCRIPTION OF THE EMBODIMENTS

Hereinafter, various embodiments of the present disclosure will be described in detail with reference to the accompanying drawings so that those skilled in the art can easily carry out them. The present disclosure may be modified in various different ways, and is not limited to the embodiments set forth herein.

Portions that are irrelevant to the description will be omitted to clearly describe the present disclosure, and same or like reference numerals designate same elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of a part and an area are exaggerated.

Further, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, a certain part being located “above” or “on” a reference portion means the certain part being located above or below the reference portion and does not particularly mean the certain part “above” or “on” toward an opposite direction of gravity.

Further, throughout the description, when a portion is referred to as “including” or “comprising” a certain component, it means that the portion can further include other components, without excluding the other components, unless otherwise stated.

Further, throughout the description, when it is referred to as “planar”, it means when a target portion is viewed from the upper side, and when it is referred to as “cross-sectional”, it means when a target portion is viewed from the side of a cross section cut vertically.

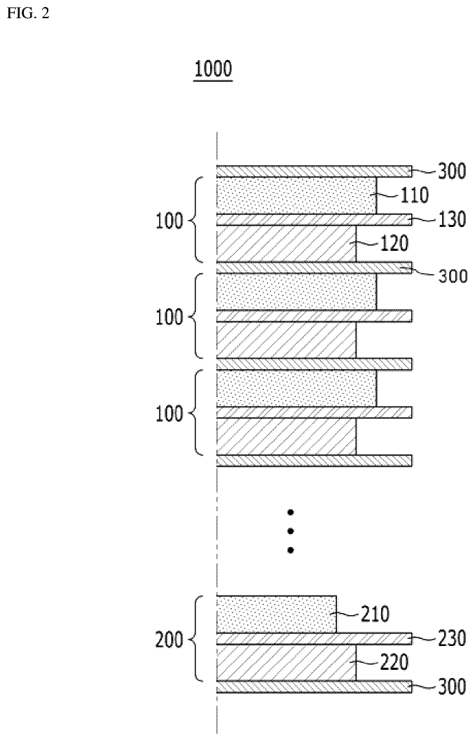

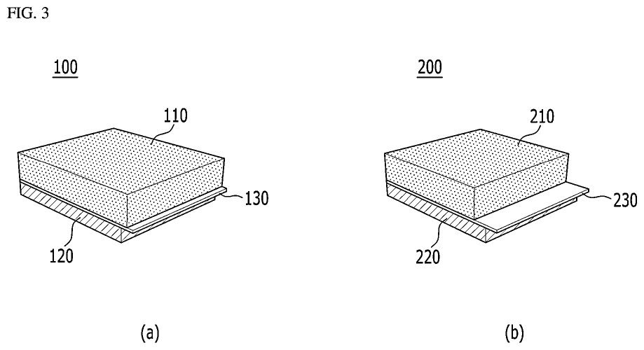

FIG. 2 is a side view of an electrode assembly according to one embodiment of the present disclosure. FIG. 3(a) is a perspective view of a first unit cell constituting the electrode assembly according to one embodiment of the present disclosure. FIG. 3(b) is a perspective view of a second unit cell constituting an electrode assembly according to one embodiment of the present disclosure.

Referring to FIG. 2, the electrode assembly 1000 is a stacked electrode assembly and includes a first unit cell 100, a second unit cell 200 and a third separator 300. The electrode assembly 1000 of FIG. 2 schematically shows one region when the central portion of the electrode assembly 1000 is cut in the z-axis direction.

More specifically, referring to FIGS. 2 and 3 (a), the first unit cell 100 has a structure in which a first positive electrode 120, a first separator 130, and a first negative electrode 110 are stacked. Specifically, the first unit cell 100 has a structure in which the end of the first negative electrode 110 protrudes more than the end of the first positive electrode 120. That is, the length of the first negative electrode 110 of the first unit cell 100 may be longer than the length of the first positive electrode 120. However, the lengths of the first negative electrode 110 and the first positive electrode 120 may be shorter than the length of the first separator 130. Therefore, the end of the first separator 130 exist in a state that it is not adhered to the first negative electrode 110 or the first positive electrode 120.

Referring to FIGS. 2 and 3 (b), the second unit cell 200 has a structure in which a second positive electrode 220, a second separator 230, and a second negative electrode 210 are stacked. More specifically, the second unit cell 200 has a structure in which the end of the second positive electrode 220 protrudes more than the end of the second negative electrode 210. That is, the length of the second positive electrode 220 of the second unit cell 200 may be longer than the length of the second negative electrode 210. In this case, the difference between the length of the second negative electrode 210 and the length of the second positive electrode 220 may be less than 1%.

However, the lengths of the second negative electrode 210 and the second positive electrode 220 may be shorter than the length of the second separator 230. Therefore, the end of the second separator 230 exists in a state that it is not adhered to the second negative electrode 210 or the second positive electrode 220.

At this time, since the length of the second negative electrode 210 is shorter than the length of the second positive electrode 220, the distance between the end of the second negative electrode 210 and the end of the second separator 230 may be longer than the distance between the end of the second positive electrode 220 and the end of the second separator 230.

Referring to FIG. 2, the third separator 300 is stacked while being located between the first unit cell 100 and the second unit cell 200, and also is located while being in contact with one surface of the first unit cell 100 and the second unit cell 200 located at the outermost side.

That is, the third separator 300 is located between the first unit cell 100 and the second unit cell 200, so that it serves to insulate the first unit cell 100 and the second unit cell 200. Further, the third separator 300 plays the same role as the first separator 130 of the first unit cell 100 and the second separator 230 of the second unit cell 200, and may be formed of the same material.

In FIG. 2, the first unit cell 100 and the second unit cell 200 constituting in the electrode assembly 1000 according to one embodiment of the present disclosure may be respectively provided in one or more numbers. That is, the total number of the first unit cell 100 and the second unit cell 200 may be two or more.

In one example, the total number of the first unit cells 100 and the second unit cells 200 constituting the electrode assembly 1000 may be twenty, and specifically, the electrode assembly may consist of nineteen first unit cells 100 and one second unit cell 200. In this case, when a plurality of first unit cells 100 are stacked to form a stacked body, the second unit cell 200 may be provided adjacent to the first unit cell 100 located at the outermost side in the stacking direction of the stacked body. That is, the second unit cell 200 may be the outermost unit cell of the stacked body.

However, the electrode assembly 1000 is not limited to the above structure. Further, the numbers of the first unit cell 100 and the second unit cell 200 are not limited to those described above, and can be changed arbitrarily by the user. For example, the second unit cells 200 may be located at both outermost sides of a stacked body in which a plurality of first unit cells 100 are stacked, and may be formed while at least one or more second unit cells 200 are located between the first unit cells 100. That is, the number of second unit cells 200 may be at least one. In this case, as the number of second unit cells 200 increases, the maximum voltage of the battery during overcharge may decrease.

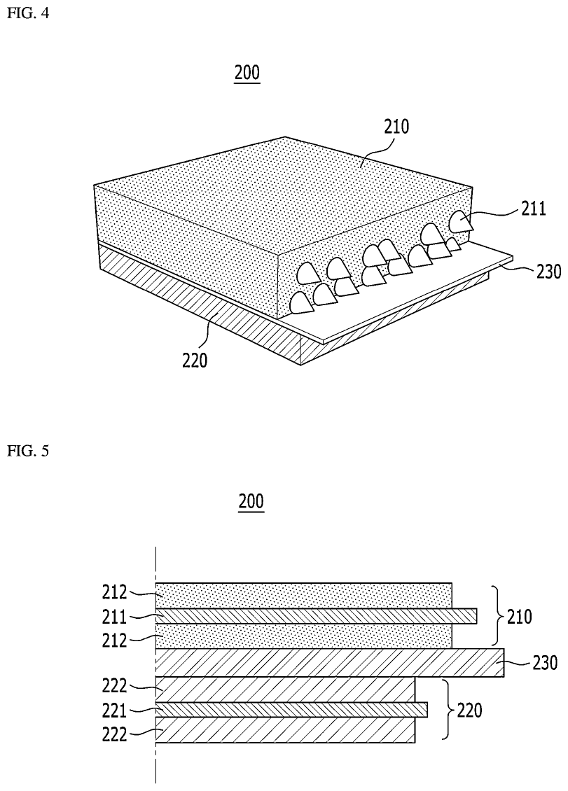

FIG. 4 is a perspective view showing a second unit cell in an overcharged state according to one embodiment of the present disclosure.

Referring to FIG. 4, in a state where an overvoltage is applied to the battery to cause overcharge, the second unit cell 200 according to one embodiment of the present disclosure deposits lithium (Li) to short-circuit a battery.

Typically, the operating range of a lithium secondary battery does not exceed 4.5V. However, due to an operation abnormality of a charger or a BMS (Battery Management System), an issue in which the battery is overcharged with a voltage of 4.5V or higher may occur.

When the battery is overcharged, since the end of the second positive electrode 220 of the second unit cell 200 protrudes more than the end of the second negative electrode 210, the second negative electrode 210 is overcharged more than the second positive electrode 220, which easily causes lithium deposition.

More specifically, the reason why lithium is deposited on the second negative electrode 210 of the second unit cell 200 is as follows. When the end of the second positive electrode 220 protrudes more than the end of the second negative electrode 210, the capacity appearance of the locally protruding second positive electrode 220 becomes larger than the capacity appearance of the second negative electrode 210. In this case, extra lithium ions that are not inserted into the second negative electrode 210 during charging are generated in the form of lithium deposition.

That is, when the same voltage is applied to the first unit cell 100 and the second unit cell 200, lithium is not deposited in the first unit cell 100, but lithium may be deposited in the second unit cell 200. In this case, due to the lithium deposited in the second unit cell 200, a short circuit of the battery may occur, so that the stability of the battery can be improved by preventing the voltage from rising.

That is, the electrode assembly according to one embodiment of the present disclosure including the second unit cell 200 allows the deposition of lithium at a lower potential compared to the conventional electrode assembly consisting of the first unit cell 100 alone. Such deposition of lithium causes a short circuit at the negative electrode, which prevents the voltage of the battery from rising and thus improve the stability of the battery.

FIG. 5 is a side view of a unit cell constituting an electrode assembly according to one embodiment of the present disclosure.

In FIG. 5, the second negative electrode 210, the second positive electrode 220, and the second separator 230 constituting the second unit cell 200 described in FIGS. 2 to 4 will be described in detail. The first unit cell 100 differs from the second unit cell 200 only in the length of the positive electrode and the negative electrode, all other configurations are the same, and therefore, the second unit cell 200 will be mainly described herein.

Referring to FIG. 5, the second negative electrode 210 is formed by coating a negative electrode coating layer 212 on a negative current collector 211. The negative current collector 211 is generally made of copper (Cu), and the negative electrode coating layer 212 is located on one side and the other side of the negative electrode current collector 211. The negative electrode coating layer 212 is coated on the negative electrode current collector 211 by mixing a negative electrode active material, a conductive agent, and a binder.

The second positive electrode 220 is formed by coating the positive electrode coating layer 222 on the positive electrode (cathode) current collector 221. The cathode current collector 221 is generally made of aluminum (Al), and the positive electrode coating layer 222 is located on one side and the other side of the positive electrode current collector 221. The positive electrode coating layer 222 is coated on the cathode current collector 221 by mixing a cathode active material, a conductive agent, and a binder.

The second separator 230 is located between the second negative electrode 210 and the second positive electrode 220. Specifically, the second separator is located between the negative electrode coating layer 212 of the second negative electrode 210 and the positive electrode coating layer 222 of the second positive electrode 220. When the negative electrode coating layer 212 of the second negative electrode 210 and the positive electrode coating layer 222 come into contact with each other, a short-circuit of the battery may be generated. Thus, to prevent this problem, the second separator 230 is located between them.

TABLE 1

| | Maximum voltage (V) |
|---|---|
| Comparative Example | 6.243 |
| Experimental Example | 5.369 |

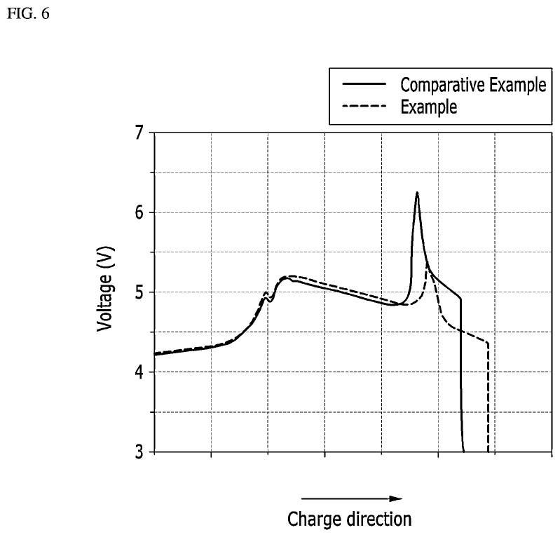

FIG. 6 is a graph showing the voltage applied to the battery during overcharge of the battery. Table 1 shows the maximum voltage applied to each of Comparative Example and Experimental Example during overcharge of the battery.

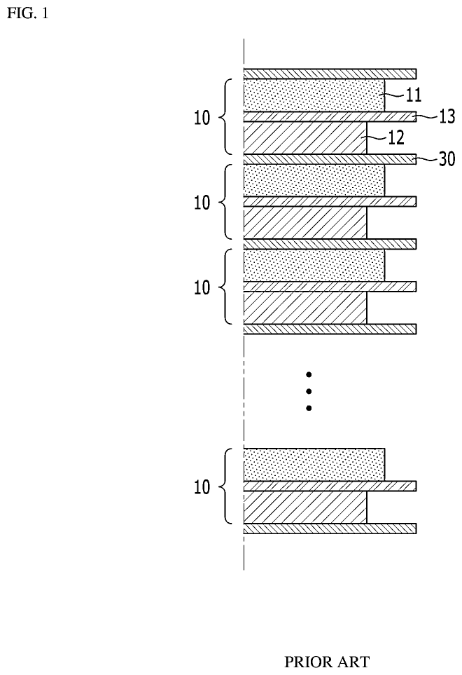

The Comparative Example is a battery including the conventional electrode assembly of FIG. 1, and the Experimental Example is a battery including an electrode assembly 1000 including the first unit cell 100 and the second unit cell 200 of FIGS. 2 and 3. Specifically, the Experimental Example is an electrode assembly 1000 including the second unit cell 200 located at the outermost side of the stacked body of the first unit cell 100, which may be an electrode assembly 1000 in which a length difference between the second negative electrode 210 and the second positive electrode 220 constituting the second unit cell 200 is 0.4%.

Referring to FIG. 6 and Table 1, it can be seen that when the battery is overcharged, the maximum voltage applied to the battery is lower in the Experimental Example, which is the battery according to one embodiment of the present disclosure.

Specifically, the experiment is to measure the maximum voltage at which a short circuit occurs when the current is applied to the battery up to 8V at a charging rate of 1C.

In the case of the Comparative Example, after the voltage rises to 6.243V during overcharging, a short circuit occurs and the voltage drops again. On the other hand, in the case of the Experimental Example, after the voltage rises to 5.369V during overcharge, a short circuit occurs and the voltage drops again. Specifically, when the voltage applied to the Experimental Example is 4.5V or more and 5.5V or less, a short circuit may occur. Referring to the above experimental results, it can be seen that the maximum voltage of the Experimental Example is about 1V lower than the maximum voltage of the Comparative Example.

Therefore, under the same experimental conditions, since the Experimental Example according to one embodiment of the present disclosure has a smaller voltage rise and a smaller maximum voltage than the Comparative Example, it can be seen that the battery is superior in terms of stability.

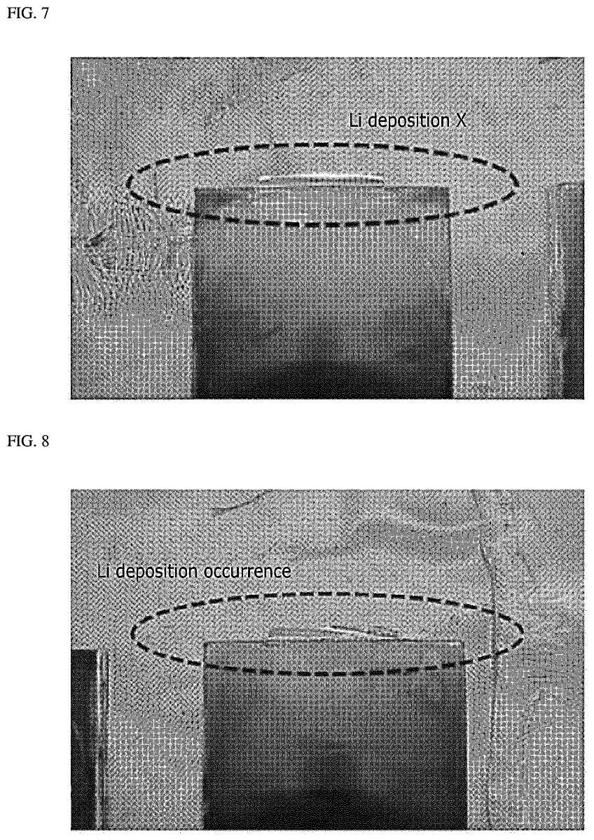

FIG. 7 is a photograph showing a conventional unit cell in an overcharged state. FIG. 8 is a photograph of a unit cell in an overcharged state according to an embodiment of the present disclosure.

The conventional unit cell is the first unit cell of FIGS. 2 and 3, and a unit cell according to one embodiment of the present disclosure may be the second unit cell of FIGS. 2 and 3.

Referring to FIGS. 7 and 8, in the same overcharged state, no lithium is deposited in the first unit cell, but lithium is deposited in the second unit cell. That is, the battery cell including the second unit cell deposits lithium at the same potential as the battery cell including only the first unit cell. In addition, in a battery cell including the second unit cell, lithium is easily deposited at a potential than lower than that of a battery cell composed only of the first unit cell. Specifically, in the second unit cell, lithium may be deposited when the voltage applied to the second unit cell is 4.5 V or more and 5.5 V or less.

A battery cell including a unit cell according to one embodiment of the present disclosure deposits lithium at a predetermined voltage or more, thereby suppressing an increase in voltage, and thus improving stability compared to a conventional battery cell.

The above-mentioned electrode assembly and a battery cell including the same can be applied to battery modules, battery packs, and various devices. Such devices can be applied to a vehicle means such as an electric bicycle, an electric vehicle, or a hybrid vehicle, but the present disclosure is not limited thereto, and is applicable to various devices that can use a battery module and a battery cell including the same, which is also falls under the scope of the present disclosure.

Although the invention has been illustrated and described above with reference to preferred embodiments thereof, the scope of the present disclosure is not limited thereto, and numerous other variations and modifications can be made by those skilled in the art, without departing from the spirit and scope of the principles of the invention described in the appended claims.

### DESCRIPTION OF REFERENCE NUMERALS

1000: electrode assembly
100: first unit cell
110: first negative electrode
120: second negative electrode
130: first separator
200: second mono-cell
210: second negative electrode
220: second positive electrode
230: second separator
300: third separator

1. An electrode assembly configured to stack a plurality of unit cells including a negative electrode, a positive electrode and a separator and that includes a separator located between the plurality of unit cells, the electrode assembly comprising:
a first unit cell in which an end of the negative electrode protrudes more than an end of the positive electrode; and
a second unit cell in which an end of the positive electrode protrudes more than an end of the negative electrode.

2. The electrode assembly of claim 1, wherein:
the second unit cell includes a second negative electrode, a second positive electrode, and a second separator located between the second negative electrode and the second positive electrode,
an end of the second positive electrode protrudes more than an end of the second negative electrode, and
a length of the second positive electrode is longer than a length of the second negative electrode.

3. The electrode assembly of claim 2, wherein:
a difference between the length of the second negative electrode and the length of the second positive electrode is less than 1%.

4. The electrode assembly of claim 2, wherein:
a difference between the length of the second negative electrode and the length of the second positive electrode is 0.4% or less.

5. The electrode assembly of claim 2, wherein:
a distance between an end of the second negative electrode and an end of the second separator is greater than a distance between an end of the second positive electrode and an end of the second separator.

6. The electrode assembly of claim 1, wherein:
the second unit cell deposits lithium at a potential lower than that of the first unit cell.

7. The electrode assembly of claim 6, wherein:
the second unit cell deposits lithium when the voltage applied to the second unit cell is between 4.5V and 5.5V.

8. The electrode assembly of claim 6, wherein:
the second unit cell is configured such that a capacity appearance of the positive electrode of the second unit cell is greater than a capacity appearance of the negative electrode of the second unit cell.

9. The electrode assembly of claim 1, wherein:
the first unit cell is provided in a plurality of first unit cells.

10. The electrode assembly of claim 9, wherein:
the plurality of first unit cells are stacked to form a stacked body, and the second unit cell is provided adjacent to a first unit cell located at the outermost side in the stacking direction of the stacked body.

11. The electrode assembly of claim 10, wherein:
the second unit cell is an outermost unit cell.

12. The electrode assembly of claim 9, wherein:
the second unit cell is located between the plurality of first unit cells.

13. The electrode assembly of claim 1, wherein:
as a number of the second unit cell increases, a maximum voltage during overcharge of the battery decreases.

14. A battery cell comprising the electrode assembly as set forth in claim 1.
